(19) United States
(12) Patent Application Publication
(10) Pub. No.: US 2003/0219118 A1
(43) Pub. Date: Nov. 27, 2003

(54) Optimized multiplicative inverse

(76) Inventor: Harlan T. Beverly, McDade, TX (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/155,302

(22) Filed: May 23, 2002

(51) Int. Cl. H04L 9/00

(52) U.S. Cl. 380/28

(57) ABSTRACT

A method, device and cipher for performing an optimized multiplicative inverse on received data in substantially real-time and without use of a look-up table. The received data represented as a Galois field GF(2^{N}) values.

### FIELD

Embodiments of the invention relate to the field of data security, in particular, to a device and method for computing a multiplicative inverse used by cryptographic ciphers over a finite Galois field.

### GENERAL BACKGROUND

Over the last decade, computers have become an important product for both commercial and personal use, in part due to their versatility. For example, computers are commonly used as a vehicle to transfer information over a private network or a public network. A “private network” may be considered to be any network having restricted access (e.g., a local area network) while a “public network” is any network allowing access to the public at large such as the Internet. In many situations, it may be desirable to encrypt digital data prior to transmission over through the network so that the transmitted data is clear and unambiguous to a targeted recipient, but it is incomprehensible to any illegitimate interlopers.

In 2001, the National Institute of Standards in Technology approved a data security process referred to as the “Advanced Encryption Standard.” The Advanced Encryption Standard (AES) details the use of a symmetric block cipher, referred to herein as the “AES cipher,” for encrypting and decrypting digital data using cipher keys. These cipher keys may have lengths varying from 128, 192, or 256 bits. AES and the AES cipher are described in a Federal Information Processing Standards Publication 197 (FIPS PUB 197) entitled “Advanced Encryption Standard (AES),” which was published on or around Nov. 26, 2001.

In general, the AES cipher features a non-linear byte substitution and operates on each byte of a two-dimensional array of bytes using a substitution table. This invertible substitution table, referred to as the “S-BOX,” is constructed by composing two transformations; namely, computing a multiplicative inverse in a finite Galois field (GF(2⁸)) as described in Section 4.2 of FIPS PUB 197 and applying an affine transformation over GF(2) as described in Section 5.1 of FIPS PUB 197. A “Galois field” is a field of integers modulo a prime number “P”, and thus each value in the field is guaranteed to have a multiplicative inverse that is also in GF(p).

One disadvantage associated with the current S-BOX implementation is that it involves a look-up table that finds pre-calculated values for an S-BOX algorithm. The use of a look-up table in a hardware implementation adversely effects the data transmission speed that the AES cipher can support. For instance, each access of the look-up table uses one clock cycle so multiple accesses of the look-up table virtually precludes AES or any other cipher using an S-BOX approach to sustain high speed data transmissions of 10 gigabits or greater.

Another disadvantage associated with the S-BOX implementation is that it requires a substantial amount of overall physical chip area, especially memory to store the look-up table. This would likely need to be dedicated memory in efforts to support higher speed transmissions. Such dedicated memory would be placed on chip or externally, requiring additional costs to be incurred.

### BRIEF DESCRIPTION OF THE DRAWINGS

The invention may best be understood by referring to the following description and accompanying drawings that are used to illustrate embodiments of the invention.

FIG. 1 is an exemplary embodiment of a system utilizing an embodiment the invention.

FIG. 2 is an exemplary embodiment of a device implemented with an embodiment of the invention.

FIGS. 3-1 and 3-2 collectively are exemplary embodiment of the operations performed by the device to produce a multiplicative inverse of a data byte.

FIG. 4 is an exemplary embodiment of GF(2⁸) shift logic of FIGS. 3-1 and 3-2.

FIG. 5 is an exemplary embodiment of computations performed by any GF(2⁸) shift logic and GF(2⁸) multiplication logic combination.

FIG. 6 is an exemplary embodiment of a flow chart illustrating the operations of parallel processing to compute the multiplicative inverse utilized for encryption and decryption according to a selected cipher.

### DETAILED DESCRIPTION

In general, various embodiments of the invention describe a system and method for protecting electronic data. In one embodiment of the invention, the electronic data is protected by a cipher that encrypts data prior to transmission over a communication link and/or decrypts data received over the communication link. One operation of this cipher is a multiplicative inverse operation that has now been optimized to support higher level data transmission speeds.

The following detailed description is presented largely in terms of block diagrams and flow charts to collectively illustrate embodiments of the invention. Well known circuits or process operations are not discussed in detail to avoid unnecessarily obscuring the understanding of this description.

Certain terminology is used to describe certain features of the embodiments of the invention. For example, a “device” may be any electronic product supporting encryption and/or decryption functionality. Such products may include, for example, a computer (e.g., desktop, portable laptop or hand-held, server, mainframe, etc.), peripherals (e.g., printer, plotter, facsimile machine, etc.), computer card add-ons (e.g., graphics card, network card, modem card, etc.), set-top box, consumer electronics (e.g., television, cellular phone, personal digital assistant “PDA”), a game console, communication equipment (e.g., a router, switch, etc.), or the like.

Normally, the device comprises internal logic, namely hardware, software, software module(s) or any combination thereof. A “software module” is a series of instructions that, when executed, performs a certain function. Examples of a software module include an operating system, an application, an applet, a program or even a routine. Furthermore, software modules may be stored in a machine-readable medium, which includes, but is not limited to an electronic circuit, a semiconductor device, a read only memory (ROM), a flash memory, a type of erasable, programmable ROM (EPROM) or (EEPROM), a floppy diskette, a compact disc, an optical disk, a hard disk, or the like.

In addition, a “cipher” is a series of transformations that convert data in an unprotected format (sometimes referred to as “plaintext”) into data in a protected format (sometimes referred to as “ciphertext”). One example of ciphertext is data encrypted by a cipher. A “byte” is a group of eight bits of data.

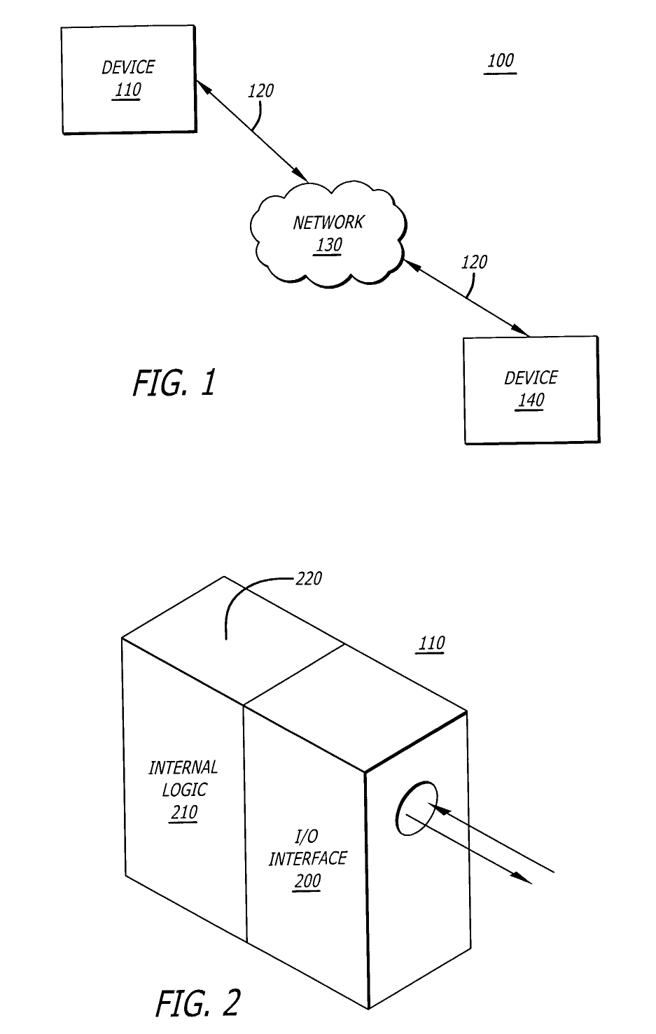

Referring to FIG. 1, an exemplary embodiment of a communication system 100 is shown. The communication system 100 includes a device 110 that is adapted to transmit ciphertext over a communication link 120. Being a part of a network 130, either public or private, the communication link 120 operates as a communication pathway by providing a wired or wireless information-carrying medium for the ciphertext. Such information-carrying medium includes, for example, electrical wire(s), optical fiber, cable, bus traces, or air supporting radio frequency (RF), infrared (IR) or another wireless communication scheme such as Bluetooth™ or HyperLAN-based communications.

Herein, for this embodiment of the invention, the ciphertext is based on data encrypted prior to transmission through the network 130 for a targeted destination such as device 140. This encryption may be in accordance with any encryption function that performs a multiplicative inverse on data represented as Galois field (GF(2^{N})) values, perhaps followed by an affine transformation. The cipher performing such encryption may be such as the Advanced Encryption Standard (AES) cipher for example. The AES cipher is described in a Federal Information Processing Standards Publication 197 (FIPS PUB 197) entitled “Advanced Encryption Standard (AES),” which was published on or around Nov. 26, 2001.

The ciphertext is received by the device 140 and decrypted by performing an inverse affine transformation (if used) followed by the multiplicative inverse. This order of operations differs from the encryption aspect where the multiplicative inverse is performed prior to the affine transformation.

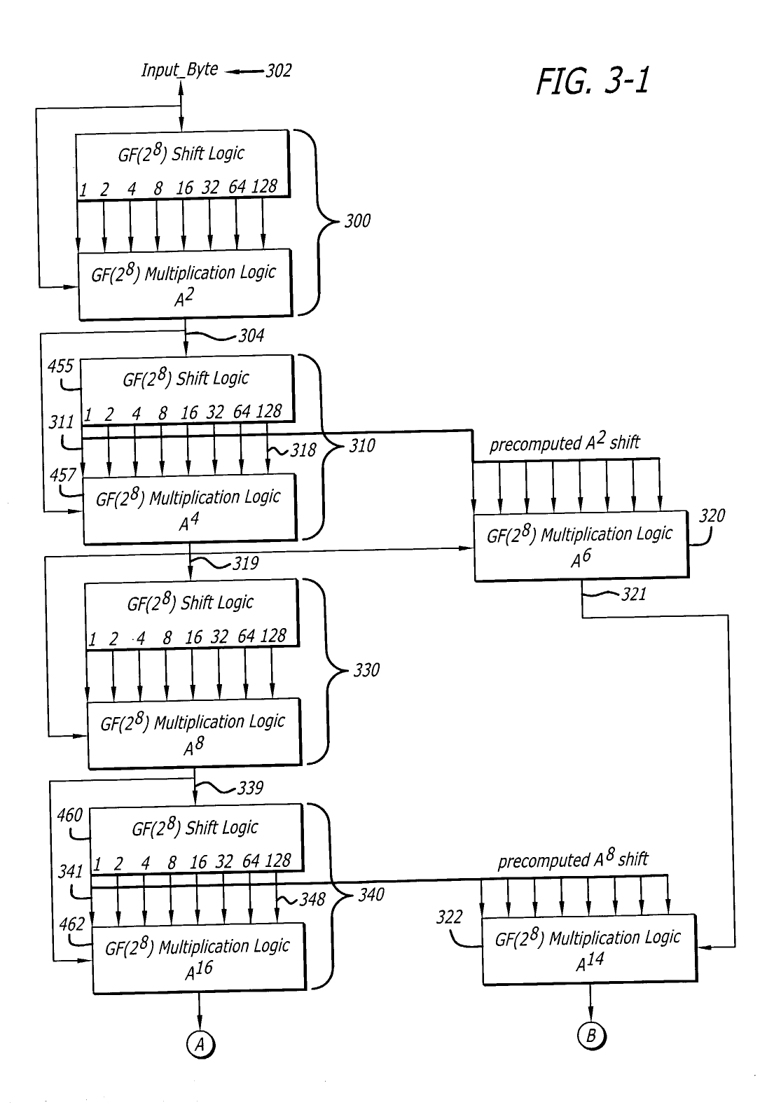

Referring now to FIG. 2, an exemplary embodiment of one of the devices (e.g., device 110) is shown. For illustrative purposes, the device 110 comprises an input/output (I/O) interface 200 and internal logic 210 to perform encryption and decryption operations. The internal logic 210 is protected by a housing 220 made of an inflexible material such as hardened plastic. This protects the internal logic 210 from damaging contaminants.

In another embodiment, FIG. 2 could represent only a portion of the overall logic that might be considered the entire communicating device. The I/O interface 200 may be the means by which the rest of the logic of such a system communicates with the internal logic 210 described in this embodiment for purposes of performing the S-BOX transformation.

More specifically, for this embodiment of the invention, the I/O interface 200 operates as a transceiver to support the reception and transmission of encrypted data. As shown, the I/O interface 200 may be implemented as a communication port adapted to transmit and/or receive streams of encrypted data. Of course, other embodiments of the I/O interface 200 may include a wired or wireless modem, a RF transceiver and antenna to receive and transmit encrypted data through RF signaling, and the like. Also, it is contemplated that the I/O interface 200 may be implemented simply as a transmitter or a receiver.

As further shown in FIG. 2, according to one embodiment of the invention, internal logic 210 performs encryption and/or decryption operations through an improved S-BOX transformation, which is now based on substantial real-time computations without use of any look-up tables. In general, this real-time S-BOX transformation involves an optimized multiplicative inverse in Galois field GF (2⁸) that relies on the Euclidean Theorem being performed on each byte of data (b₀b₁b₂b₃b₄b₅b₆b₇). The optimized multiplicative inverse, shown in FIGS. 3-1 and 3-2, may be followed by an affine transformation described in the FIPS 198 Publication and set forth in equation 1:

b′ᵢ=bᵢ+b_{(i+4)mod8}+b_{(i+5)mod8}+b_{(i+6)mod8}+b_{(i+7)mod8}+Cᵢ, (1)

for 0≦i≦8, where bᵢ is the i^{th} bit of the byte, Cᵢ is the i^{th} bit of a byte C with the value {63} or {01100011}. The prime on a variable (b′) indicates an updated variable.

Since the optimized multiplicative inverse is performed on a given byte of input data, sixteen (16) of these multiplicative inverse computations would be performed in parallel to implement a 128-bit (16-byte) real-time S-box transformation as used by a 128-bit cipher.

Referring now to FIGS. 3-1 and 3-2, an exemplary embodiment of the operations performed by the device to produce a multiplicative inverse of a data byte is shown. In accordance with the Euclidean Theorem, under multiplication in GF(2⁸), the inverse for given input A, is simply A²⁵⁴.

In general, the computation of A²⁵⁴ may be computed by iteratively multiplying two 8-bit values in GF(2⁸). This involves successive GF(2⁸) shift operations followed by a conditional bitwise Exclusive OR (XOR) of each result with one of two GF(2⁸) polynomials. More specifically, if a GF(2⁸) shift operation produces a result with an asserted carry (carry=“1”), the result is XORed with the polynomial {1B} to produce an intermediary result. Otherwise, the result is XORed with the polynomial {00} to produce the intermediary result. The polynomials { } are references as hexadecimal numbers.

Thereafter, the intermediary results are conditionally XORed with each other based on the input data, which produces an output. The output may be applied as an input in an iterative fashion to perform a squaring operation. Also, the output is now applied to be conditionally XORed with other values as described below for illustrative purposes.

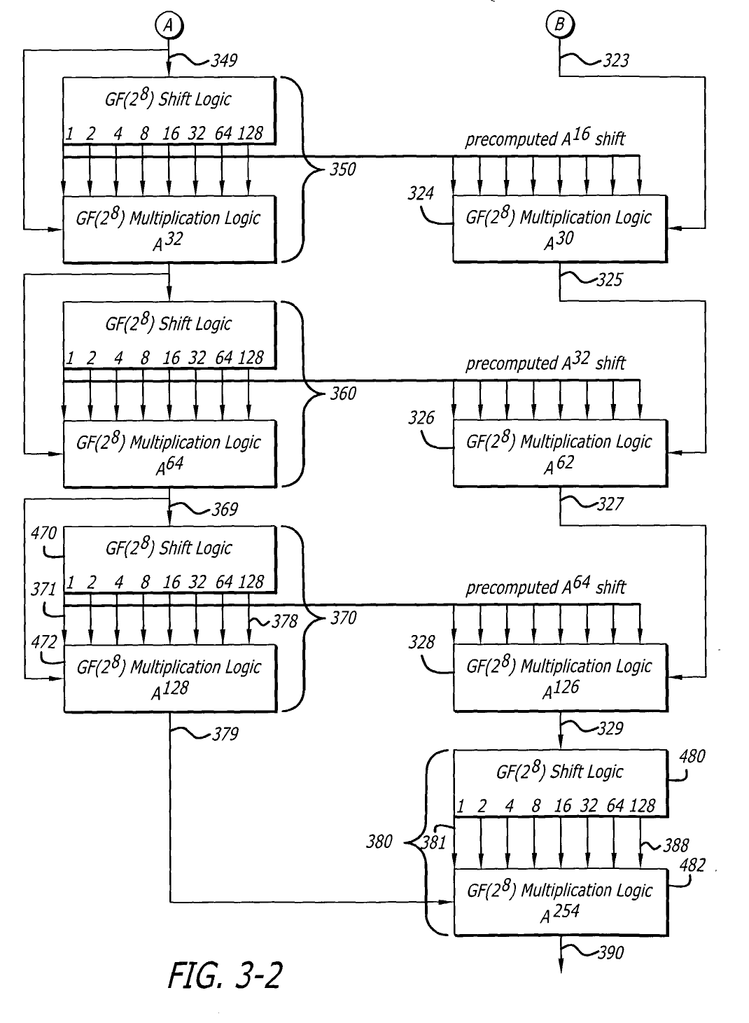

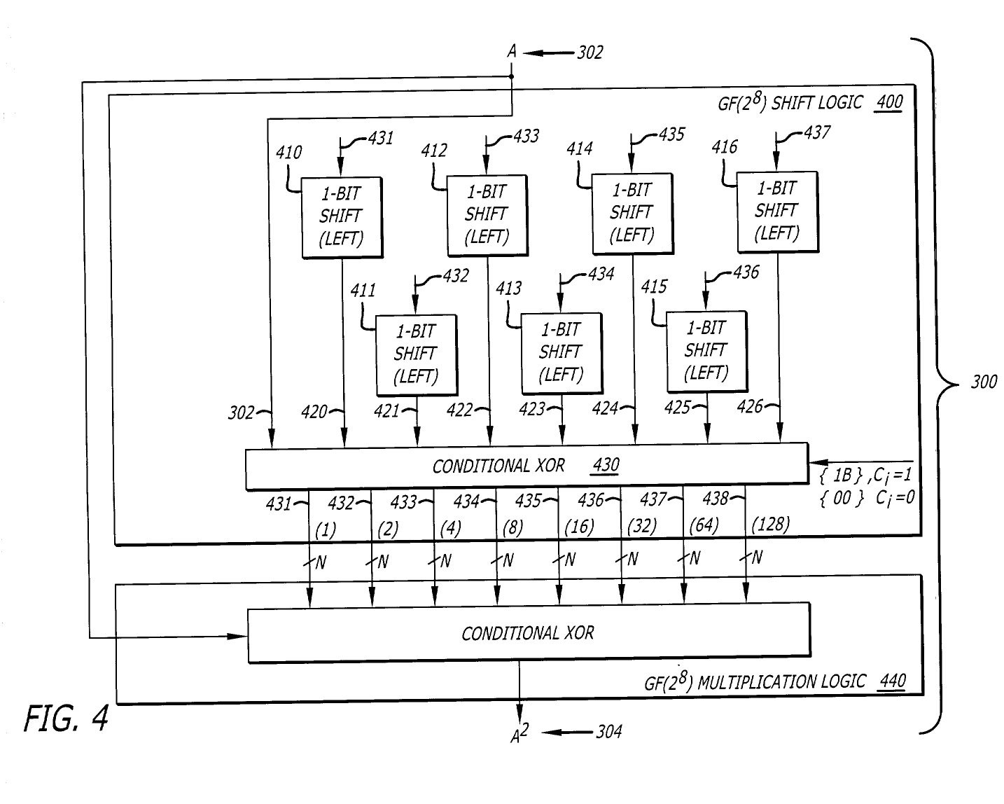

In particular, as shown in FIG. 3-1, a first multiplier 300 receives input data “A” 302 (e.g., N-bits of data, where “N” is a positive whole number) and produces a value A² 304. As shown in FIG. 4, the input data “A” 302 is one-byte in size (N=8). Thus, the first multiplier 300 comprises GF(2⁸) shift logic 400 and GF(2⁸) multiplication logic 440. In particular, GF(2⁸) shift logic 400 operates as N−1 shift elements 410-416 coupled together in a ripple fashion. For this embodiment of the invention, these shift elements 410-416 perform one-bit “LEFT” shift operations on received data. Of course, in another embodiment of the invention, shift elements 410-416 may perform one-bit “RIGHT” shift operations.

For instance, the original input data “A” 302 is provided to a conditional XOR element 430. If the input data 302 undergoes a bitwise XOR with a polynomial representation {00} to produce an intermediary result 431. For this embodiment of the invention, the intermediary result 431 is 8-bits in length. Of course, other bit sizes can be supported other than those illustrated therein. A first shift element 410 receives intermediary result 431 from the conditional XOR element 430 and performs a 1-bit LEFT shift on the input data 302 to produce a result value 420. The result value 420 is provided to the conditional XOR element 430.

If the result value 420 includes an asserted carry (carry=1), that data value 420 undergoes a bitwise XOR with a polynomial representation {1B} to produce intermediary results 432. Otherwise, the intermediary result 432 is based on value 420 XORed with a polynomial representation {00}.

Other shift elements 411-416 receive respective intermediary results 432-437 from the conditional XOR element 430 and perform 1-bit shift operations. This produces result values 421-426, respectively. These result values 421-426 are provided to the conditional XOR element 430.

If any of these result values 421, . . . , or 426 include an asserted carry (carry=1), that value 421, . . . , or 426 undergoes a bitwise XOR with a polynomial representation {1B} to produce intermediary results 433, . . . , or 438, respectively. Otherwise, the intermediary result 433, . . . , or 438, is based on value 421, . . . , or 426 XORed with a polynomial representation {00}.

The GF(2⁸) multiplication logic 440 performs a bitwise XOR operation between those intermediary result 431-438 associated with an asserted bit in the input data 302 to produce an output (A²) 304. As shown in FIG. 3-1, the output (A²) 304 is used as input to a second multiplier 310.

Referring back to FIGS. 3-1 and 3-2, second multiplier 310 performs shift operations on the input data (A²) 304 to produce an output (A⁴) 319. Namely, GF(2⁸) shift logic 455 of the second multiplier 310 performs “LEFT” ripple shift operations (of different bit widths) on the input data (A²) 304 as described in FIG. 4. Although not shown herein, the shifted results are subsequently XORed with polynomial representation {1B} if a carry is asserted for that shifted result or with a polynomial representation {00} if the carry remains deasserted. This produces intermediary results 311-318.

The GF(2⁸) multiplication logic 457 of the second multiplier 310 performs a bitwise XOR operation between the intermediary results 311-318 corresponding with asserted bits of input data (A²) 304 in order produce an output (A⁴) 319. Similar, the output (A⁴) 319 may be used as input to another GF(2⁸) multiplication logic unit 320 processed generally in parallel with output (A⁴) 319.

Besides supplying the intermediary results 311-318 to GF(2⁸) multiplication logic 457 of the second multiplier 310, these results 311-318 are also supplied to the GF(2⁸) multiplication logic unit 320. The GF(2⁸) multiplication logic unit 320 performs a bitwise XOR operation between those intermediary results 311-318 corresponding with asserted bits of input data (A²) 304 to produce an output (A⁶) 321.

Referring still to FIGS. 3-1 and 3-2, a third multiplier 330 performs shift operations on the input data (A⁴) 319. The third multiplier 325 receives the input data (A⁴) 319 and produces an output (A⁸) 339 in a manner as described in FIG. 4. This output (A⁸) 339 may be used as input to a fourth multiplier 340.

Furthermore, a fourth multiplier 340 performs shift operations on the input data (A⁸) 339. The fourth multiplier 340 receives the input data (A⁸) 339 and produces an output (A¹⁶) 349. Namely, GF(2⁸) shift logic 460 performs multiple “LEFT” ripple shift operations producing shift values of different bit sizes on the input data (A⁸) 339. These shifted results 341-348 are subsequently XORed with polynomial representation {1B} (if a carry is asserted) or a polynomial representation {00} (if the carry remains deasserted) to produce intermediary results 341-348.

GF(2⁸) multiplication logic 462 of the fourth multiplier 340 performs a bitwise XOR operation on the intermediary results 341-348 associated with asserted bits of the input data (A⁸) 339 to produce the output (A¹⁶) 349. Similar, the output (A¹⁶) 349 may be used as input to a fifth multiplier 350 and continues this process chain to a seventh multiplier 370.

The intermediary results 341-348 are further supplied to another GF(2⁸) multiplication logic unit 322. The GF(2⁸) multiplication logic unit 322 performs a bitwise XOR operation between the intermediary results 341-348 based on which bits of input data (A⁶) 321 is asserted. This produces an output (A¹⁴) 323. Similarly, GF(2⁸) multiplication logic units 324 and 326 are used to compute output (A³⁰) 325 and output (A⁶²) 327, respectively.

Referring still to FIGS. 3-1 and 3-2, seventh multiplier 370 receives the input data (A⁶⁴) 369 and produces an output (A¹²⁸) 379. This output (A¹²⁸) 379 may be used as input to an eighth multiplier 380.

In particular, GF(2⁸) shift logic 470 performs multiple “LEFT” shift operations configured in a ripple fashion to produce different bit sizes on the input data (A⁶⁴) 369. If a shifted result asserts a carry bit, that shifted result is subsequently XORed with polynomial representation {1B}. Otherwise, the shifted result is XORed with polynomial representation {00}. This produces intermediary results 371-378.

GF(2⁸) multiplication logic 472 of the seventh multiplier 370 performs a bitwise XOR operation between those intermediary results 371-378 associated with asserted bits for input data (A⁶⁴) 369. The XOR result produces the output data (A¹²⁸) 379. The output data (A¹²⁸) 379 may be used as input to GF(2⁸) multiplication logic 482 of the eighth multiplier 380.

The intermediary results 371-378 are further supplied to another GF(2⁸) multiplication logic unit 328. The GF(2⁸) multiplication logic unit 328 performs a bitwise XOR operation between intermediary results 371-378 corresponding to asserted bits of the input data (A⁶²) 327 to produce an output (A¹²⁶) 329.

Herein, the eighth multiplier 380 receives the input data (A¹²⁶) 329 from data being processed in parallel and produces an output (A²⁵⁴) 390. This output (A²⁵⁴) 390 operates as data associated with the multiplicative inverse of the input (A) 302.

In particular, GF(2⁸) shift logic 480 performs “LEFT” shift operations as set forth in FIG. 4, which provides shifts of different bit sizes on the input data (A¹²⁶) 329. If a shifted result asserts a carry bit, that shifted result is subsequently XORed with polynomial representation {1B}. Otherwise, the shifted result is XORed with polynomial representation {00}. This produces intermediary results 312-388.

GF(2⁸) multiplication logic 482 performs a bitwise XOR operation between intermediary results 381-388 corresponding to those bits of input data (A¹²⁶) 329 that are asserted to produce an output (A²⁵⁴) 390.

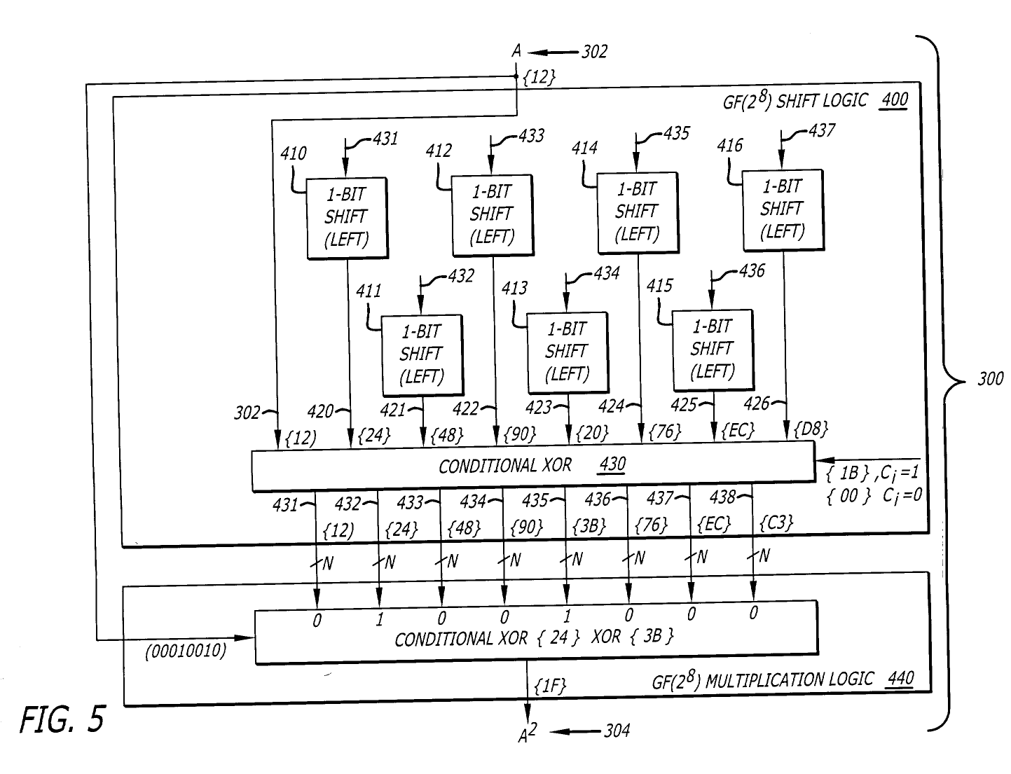

Referring now to FIG. 5, an exemplary embodiment of computations performed by any GF(2⁸) shift logic and GF(2⁸) multiplication logic combination used to produce a multiplicative inverse for input data {12} is shown. Herein, for this embodiment of the invention, operations are explained for computations in producing an output (A²) 304 from input data (A) 302. Of course, it is appreciated that these operations are consistently applied to other GF(2⁸) shift logic and GF(2⁸) multiplication logic combinations.

Herein, shift elements of the GF(2⁸) shift logic 400 provide result values {12} 302, {24} 420, {48} 421, {90} 422, {20, where intermediary value 435 is 3B} 423, {76} 424, {EC} 425 and {D8, where intermediary value 438 is D8 XOR 1B} 426.

Since the original input data “A” 302 is {12}, a second bit and fifth bit of input data “A” 302 is asserted. Thus, intermediary values {24} 432 and {3B} 435 are bitwise XORed to produce {1F} as the output data (A²) 304.

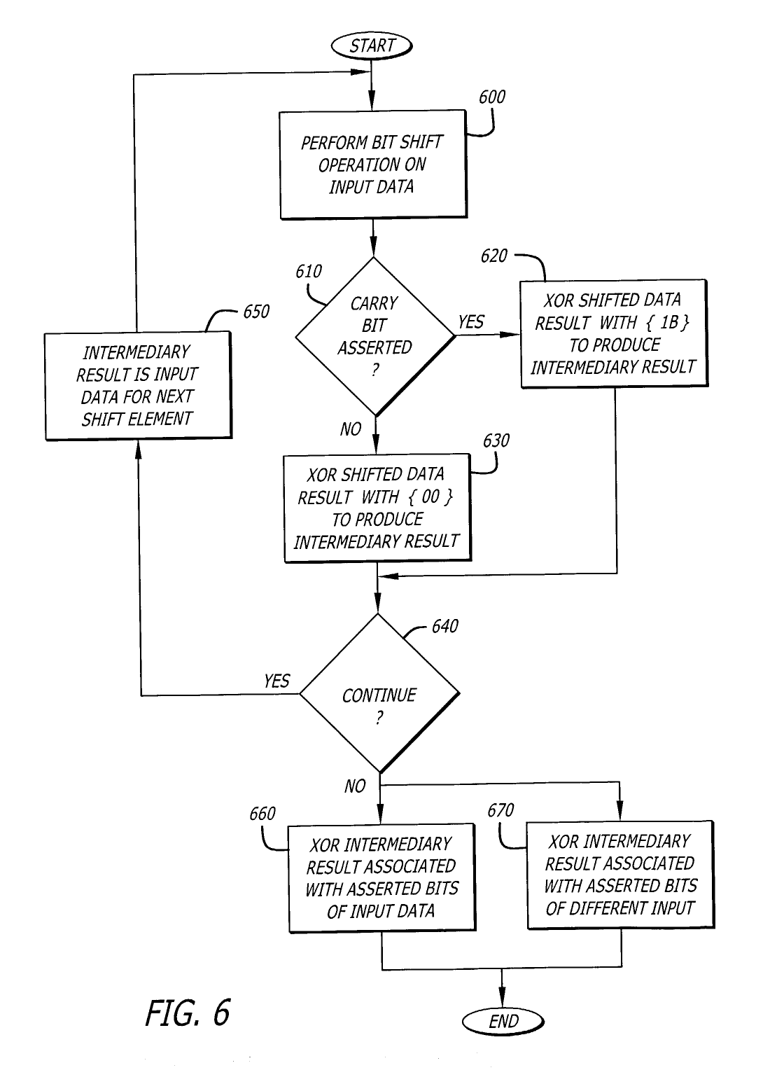

Referring now to FIG. 6, an exemplary embodiment of a flow chart illustrating the operations of parallel processing to compute the multiplicative inverse utilized for encryption and decryption according to a selected cipher is shown. Initially, input data undergoes multiple LEFT bit shifts of varying bit size to produce shifted data results.

For one embodiment of the invention, N−1 LEFT shifts are effectively conducted through a ripple coupling of the shift elements, producing shifts ranging up to N−1 bits. Namely, as set forth in block 600, a bit shift operation is performed on input data (e.g., a 1-bit shift). The output of the one-bit shift is conditionally XORed with {1B} based on a carry result. Otherwise, the output is XORed with {00} as set forth in blocks 610, 620 and 630. Thereafter, an intermediary value is produced, which if additional shifting is needed, acts as an input to a second one-bit shift element to produce a 2-bit shifted data result as set forth in blocks 640 and 650. These operations are iterative in nature to produce multiple intermediary results.

As shown in block 660, if the input data has two or more (M) bits asserted, those intermediary results corresponding to these “M” bits are bitwise XORed together to produce an output. If only one bit is asserted, the output is equal to the intermediary result associated with the asserted bit of the input data.

In parallel with the generation of the output, as needed, the intermediary results are also provided to circuitry that performs bitwise XORing of those intermediary results associated with asserted bits of input data to that circuitry (block 670). This scheme continues, as needed, to produce additional non-squared outputs in parallel to the squaring operations that produce binary factors A², A⁴, A⁸, A¹⁶, etc. A selected one of these additional parallel outputs can subsequently undergo a GF(2^{N}) shift operation and a GF(2^{N}) multiplication operation with one of the binary factor outputs to produce a multiplicative inverse for the input data (A).

It should be noted that the multiplication order of getting the A²⁵⁴ result are many and varied. For this embodiment, A² and other computational values are combined to make A¹²⁸ which combines with A¹²⁶ to create the A²⁵⁴ There are many different multiplication factors which might combine to produce A²⁵⁴, including but not limited to A²⁵³*A¹ and so on. Intermediate multiplications may also be many and varied. For example to achieve A⁶², A⁶¹*A¹ may be used, A⁶⁰*A² may be used and so on.

While the invention has been described in terms of several embodiments, the invention should not limited to only those embodiments described, but can be practiced with modification and alteration within the spirit and scope of the appended claims. The description is thus to be regarded as illustrative instead of limiting.

What is claimed is:

1. A method comprising:
receiving data; and
performing a multiplicative inverse on the received data in substantially real-time without use of a look-up table, the received data being a Galois field (28) value.

2. The method of claim 1, wherein the performing of the multiplicative inverse comprises conducting a separate multiplicative inverse computation on each byte of input data.

3. The method of claim 1 wherein the performing of the multiplicative inverse comprises iterative multiplication of two values in Galois field (2⁸).

4. The method of claim 3, wherein the performing of the multiplicative inverse through iterative multiplication comprises:
performing a shift operation on the data to produce a first result; and
performing a first conditional Exclusive OR (XOR) operation between the first result and one of at least two polynomials in Galois field (2⁸) to produce a first intermediary result.

5. The method of claim 4, wherein a first polynomial of the at least two polynomials is a hexadecimal representation of {1B} being used when the first result has an asserted carry.

6. The method of claim 5, wherein a second polynomial of the at least two polynomials is a hexadecimal representation of {00} being used when the first result has an unasserted carry.

7. The method of claim 6, wherein the performing of the multiplicative inverse through iterative multiplication further comprises:
performing a shift operation on the first intermediary result to produce a second result; and
performing a second conditional Exclusive OR operation between the second result and one of the at least two polynomials to produce a second intermediary result.

8. The method of claim 4, wherein the performing of the multiplicative inverse through iterative multiplication further comprises:
iteratively performing shift operations on intermediary results to produce shifted results, one of the shifted results being successively produced from the first intermediary result; and
iteratively performing conditional Exclusive OR (XOR) operations between the shifted results and one of the at least two polynomials to produce a plurality of intermediary results.

9. The method of claim 8, wherein the performing of the multiplicative inverse through iterative multiplication further comprises:
performing conditional Exclusive OR (XOR) operations on at least two of the plurality of intermediary results that correspond to asserted bits of the received data to produce a first output data, the first output data being a squared factor of the input data.

10. The method of claim 9, wherein the performing of the multiplicative inverse through iterative multiplication further comprises:
performing conditional Exclusive OR (XOR) operations on at least two of the plurality of intermediary results that correspond to asserted bits of a non-squared factor of the received data to produce a second output data.

11. The method of claim 10, wherein the performing of the multiplicative inverse through iterative multiplication further comprises:
multiplying the first output data by the second output data to produce a value being an inverse of the received data.

12. A cipher embodied in a machine-readable medium executed by internal logic, the cipher comprising:
a software module to perform a multiplicative inverse on input data in substantially real-time without use of a look-up table by performing iterative multiplication of two values in Galois field (2^{N}) where “N” is a positive integer; and
a software module to perform an affine transformation on the inversed data.

13. The cipher of claim 12, wherein the software module performs the multiplicative inverse on input data by conducting a separate multiplicative inverse computation on each byte of the input data.

14. The cipher of claim 13, wherein the software module performing of the multiplicative inverse through iterative multiplication comprises:
a first software module to perform a shift operation on the input data to produce a first result; and
a second software module to perform a first conditional Exclusive OR (XOR) operation between the first result and one of at least two polynomials in Galois field (2^{N}) to produce a first intermediary result.

15. The cipher of claim 14, wherein the software module performing of the multiplicative inverse through iterative multiplication further comprises:
the first software module iteratively performing shift operations on intermediary results to produce shifted results, the shifted results being successively produced from the first intermediary result; and
the second module iteratively performing conditional Exclusive OR (XOR) operations between the shifted results and one of the at least two polynomials to produce a plurality of intermediary results.

16. The cipher of claim 15, wherein the software module performing of the multiplicative inverse through iterative multiplication further comprises:
a third software module to perform conditional Exclusive OR (XOR) operations on at least two of the plurality of intermediary results that correspond to asserted bits of the input data to produce a first output data, the first output data being a squared factor of the input data.

17. The cipher of claim 16, wherein the software module performing of the multiplicative inverse through iterative multiplication further comprises:
a fourth software module to perform conditional Exclusive OR (XOR) operations on at least two of the plurality of intermediary results that correspond to asserted bits of a non-squared factor of the input data to produce a second output data.

18. The cipher of claim 17, wherein the software module performing of the multiplicative inverse through iterative multiplication further comprises:
a fifth software module to multiply the first output data by the second output data to produce a value being an inverse of the input data.

19. A device comprising:
an input/output (I/O) interface to receive data; and
internal logic to perform a multiplicative inverse on the received data, including
a first plurality of multipliers, each including shift logic and multiplication logic, to perform iterative shift and conditional Exclusive OR (XOR) operations to produce squared factors of the received data in Galois field (2^{N}) where “N” is a positive integer,
a second plurality of multipliers to perform iterative conditional (XOR) operations on intermediary results produced by the shift logic of at least one of the first plurality of multipliers to produce non-squared factors of the received data in Galois field (2^{N}), and
a multiplier to combine a first output data being a squared factor of the received data with a serial output data being a non-squared factor of the received data.

20. The device of claim 19, wherein the shift logic of a first multiplier performs a shift operation on the received data to produce a first result and performs a first conditional Exclusive OR between the first result and one of at least two polynomials in Galois field (2^{N}) to produce a first intermediary result.

21. The device of claim 20, wherein the shift logic of the first multiplier further performs shift operations on the first intermediary result to produce a second shift result and to perform a conditional XOR operation between the second shift result and one of the at least two polynomials to produce a second intermediary result.

22. The device of claim 20, wherein the shift logic of the first multiplier further performs shift operations on the second intermediary results and following intermediary results to produce shift results and to perform conditional Exclusive OR operations between the shift results and one of the at least two polynomials to produce a plurality of intermediary results including the first and second intermediary results.

23. The device of claim 22, wherein the multiplication logic of the first multiplier performs conditional XOR operation on at least two of the plurality of intermediary results that correspond to asserted bits of the received data to produce the first output data.
